(19) United States
(12) Patent Application Publication
(10) Pub. No.: US 2007/0220235 A1
(43) Pub. Date: Sep. 20, 2007

(54) Instruction subgraph identification for a configurable accelerator

(75) Inventors: Sami Yehia, Paris (FR); Krisztian Flautner, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/375,572

(22) Filed: Mar. 15, 2006

(51) Int. Cl. G06F 9/40

(52) U.S. Cl. 712/205

(57) ABSTRACT

An integrated circuit 2 includes a configurable accelerator 14. An instruction identifier 22 identifies subgraphs of program instructions which are capable of being performed as combined complex operations by the configurable accelerator 14. The subgraph identifier 22 reorders the sequence of fetched instructions to enable larger subgraphs of program instructions to be formed for acceleration and uses a postpone buffer 24 to store any postponed instructions which have been pushed later in the instruction stream by the reordering action of the subgraph identifier 22.

### BACKGROUND OF THE INVENTION

1. Field of the Invention

This invention relates to the field of data processing systems. More particularly, this invention relates to the identification of instruction subgraphs for integrated circuits including configurable accelerators operating to perform as a combined complex operation a plurality of data processing operations corresponding to execution of a plurality of program instructions (i.e. an instruction subgraph), which may be adjacent or non-adjacent.

2. Description of the Prior Art

Application-specific instruction set extensions are gaining popularity as a middle-ground solution between ASICs and programmable processors. In this approach, specialised hardware computation blocks are tightly integrated into a processor pipelined and exploited through the use of specialised instructions. These hardware computation blocks act as accelerators to execute portions of an application's data flow graph as atomic units. The use of subgraph accelerators reduces the latency of the subgraph's execution, improves the utilisation of pipeline resources and reduces the burden of storing temporary values to the register files. Unlike ASIC solutions, which are hardwired and hence intolerant to changes in the application, instruction set extensions do not sacrifice the post-programmability of the device. Several commercial tool chains such as Tensilica Xtensa, ARC Architect and ARM OptimoDE, make effective use of instruction set extensions. There are two general approaches for implementing instruction set extensions: visible and transparent. The visible approach is most commonly employed by commercial tool chains to explicitly extend a processor's instruction set. This approach employs an application specific instruction processor, or ASP, where a customised processor is created for a particular application domain. This method has the advantage of simplicity, flexibility and low accelerator cost. However, it also suffers from high recurring engineering costs.

Unlike instruction set extensions, transparent instruction set customisation is a method wherein subgraph accelerators are exploited in the context of a general purpose processor. Thus, a fixed processor design is maintained and the instruction set is unaltered. The central difference from the visible approach is that the subgraphs are identified and control is general on-the-fly to map and execute data flow subgraphs onto the accelerator.

The main elements of transparent instruction set customisation are two-fold:

1. Identifying and extracting candidate subgraphs of the application that speed up programs.

2. Defining an appropriate re-configurable hardware accelerator and its associated configuration generator.

The second of these elements has been addressed previously, see References 1, 2 and 4 (see below). The present technique is concerned primarily with the first element mentioned above.

Previously proposed approaches to extracting subgraphs from applications target extracting the largest possible subgraph from the application. Extracting large subgraphs can be done either using a compiler or dynamic optimisation framework that allows analysis of large traces of dynamic instructions using offline dynamic optimisers. The approach in Reference 1 investigated a compiler technique to extract subgraphs and delimit them with special instructions that would allow the hardware to recognize the subgraph and to accelerate the subgraph. Also, References 1 and 2 proposed hardware approaches to dynamically extracting subgraphs using a dynamic optimisation framework.

The previously proposed compiler approach has the disadvantage of introducing special delimiting instructions or special purpose branch instructions to identify subgraphs. Thus, legacy code or code generated by a compiler that does not support accelerators, will not benefit from processors that support transparent accelerators of such a type. Moreover, although the compiler approach can cope with some variations in accelerator design, it still is based upon certain assumptions about the nature and capabilities of the underlying accelerators. Thus, a new generation of accelerator would require a change in the compiler and may not be fully exploited by legacy code.

The previously proposed purely hardware based approaches to subgraph identification have the disadvantage of requiring a large amount of circuit overhead. The subgraph identifiers are complex and expensive in terms of gate count, cost etc. Pure hardware solutions have also been proposed targeting simple subgraphs of a more restrictive type, such as subgraphs consisting of three consecutive instructions to eliminate transient results (see Reference 3) and subgraphs that only have two inputs and one output to be mapped to three back-to-back ALUs (see Reference 5). Whilst such approaches can be implemented with relatively little gate count, power consumption, etc, they are disadvantageously limited in the size and nature of subgraphs they are able to identify. This limits the performance gains to be achieved by the use of configurable accelerators.

### SUMMARY OF THE INVENTION

Viewed from one aspect the present invention provides an integrated circuit comprising:

an instruction fetching mechanism operable to fetch a sequence of program instructions for controlling data processing operations to be performed;

a configurable accelerator configurable to perform as a combined complex operation a plurality of data processing operations corresponding to execution of a plurality of adjacent of program instructions;

subgraph identifying hardware operable to identify within said sequence of program instructions a subgraph of adjacent program instructions corresponding to a plurality of data processing operations capable of being performed as a combined complex operation by said configurable accelerator; and

a configuration controller operable to configure said configurable accelerator to perform said combined complex operation in place of execution of said subgraph of program instructions; wherein

said subgraph identifying hardware is operable to reorder said sequence of program instructions as fetched by said instruction fetching mechanism to form a longer subgraph of adjacent program instructions capable of being performed as a combined complex operation by said configurable accelerator.

The present technique recognizes that a considerable improvement in the size of instruction subgraphs that can be identified, and accordingly accelerated, may be achieved by allowing the subgraph identifier to reorder the sequence of program instructions which are fetched. Reordering the program instructions in this way allows the subgraph identifier to work with adjacent instructions considerably simplifying the task of subgraph identification and the generation of appropriate configuration controlling data for the configurable accelerator.

Particularly preferred embodiments utilize a postpone buffer to store program instructions which are fetched by the instruction fetching mechanism and not identified by the subgraph identifying hardware as part of a subgraph capable of being performed as a combined complex operation by the configurable accelerator. The postpone buffer is a small and efficient mechanism to facilitate reordering without unduly disturbing the instruction fetching mechanism or other aspects of the processor design.

The program instructions stored within the postpone buffer could be program instructions which are simply incompatible with the current subgraph for a variety of different reasons, such as configurable accelerator design limitations (e.g. number of inputs exceeded, number of outputs exceeded, etc). However, an advantageously simple preferred implementation stores program instructions into the postpone buffer when they are of a type which are not supported by the configurable accelerator, e.g. the instructions may be multiplies when the accelerator does not include a multiplier, or load/store operations when load/stores are not supported by the accelerator, etc.

In the case of program instructions not supported by the configurable accelerator, then the normal instruction execution mechanism (e.g. standard instruction pipeline) can be used to execute these instructions taken from the postpone buffer or elsewhere.

It is important that the reordering of program instructions by the subgraph identifier is subject to constraints such that the overall operation instructed by the sequence of program instructions is unaltered. A preferred way of dealing with such constraints is that a subject program instruction may be reordered so as to fall within a sequence of adjacent program instructions for a subgraph being performed, and ahead of one or more postponed program instructions not to be part of that subgraph, if the subject program instruction does not have any input dependent upon any output of the one or more postponed program instructions. Further similar constraints are that a subject program instruction may be reordered if the one or more postponed program instructions do not have any inputs which are overwritten by the subject program instruction and a subject program instruction may be reordered if the one or more postponed program instruction do not have any output which overwrites any output of the subject program instruction. Examples of cases where the first instruction cannot be postponed are:

Read After Write (RAW)
MUL r1←r2, r3
ADD r5←r1, r4

Write After Read (WAR)
MUL r3←r1, r5
ADD r1←r6, r7

Write After Write (WAW)
MUL r1←r2, r3
ADD r1←r4, r5

Enlargement of the subgraphs identified can proceed in this way with unsupported program instructions being postponed until an unsupported program instruction is encountered which cannot be postponed without changing the overall operation. A further trigger for ceasing enlargement of the subgraph is when the capabilities of the configurable accelerator would be exceeded by adding another program instruction to the subgraph (e.g. numbers of inputs, outputs or storage locations of the accelerator).

The techniques described above are advantageous in providing a hardware based, and yet hardware efficient, mechanism for the dynamic and transparent identification and collapse of program instruction subgraphs for acceleration by a configurable accelerator.

Viewed from another aspect the present invention provides a method of operating an integrated circuit comprising the steps of:

fetching a sequence of program instructions for controlling data processing operations to be performed;

identifying within said sequence of program instructions a subgraph of adjacent program instructions corresponding to a plurality of data processing operations capable of being performed as a combined complex operation by a configurable accelerator, said step of identifying including reordering said sequence of program instructions as fetched to form a longer subgraph of adjacent program instructions capable of being performed as a combined complex operation by said configurable accelerator;

configuring a configurable accelerator to perform said combined complex operation in place of execution of said subgraph of program instruction; and

performing as said combined complex operation said plurality of data processing operations corresponding to execution of a plurality of adjacent of program instructions.

Viewed from a further aspect the present invention provides an integrated circuit comprising:

an instruction fetching means for fetching a sequence of program instructions for controlling data processing operations to be performed;

configurable accelerator means for performing as a combined complex operation a plurality of data processing operations corresponding to execution of a plurality of adjacent of program instructions;

subgraph identifying means for identifying within said sequence of program instructions a subgraph of adjacent program instructions corresponding to a plurality of data processing operations capable of being performed as a combined complex operation by said configurable accelerator means; and

configuration controller means for configuring said configurable accelerator to perform said combined complex operation in place of execution of said subgraph of program instructions; wherein

said subgraph identifying means reorders said sequence of program instructions as fetched by said instruction fetching means to form a longer subgraph of adjacent program instructions capable of being performed as a combined complex operation by said configurable accelerator means.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates an integrated circuit including a configurable accelerator;

FIG. 2 schematically illustrates a sequence of program instructions both as fetched and as reordered;

FIG. 3 schematically illustrates a subgraph identification mechanism; and

FIG. 4 is a flow diagram schematically illustrating dynamic subgraph extraction.

### DESCRIPTION OF THE PREFERRED EMBODIMENTS

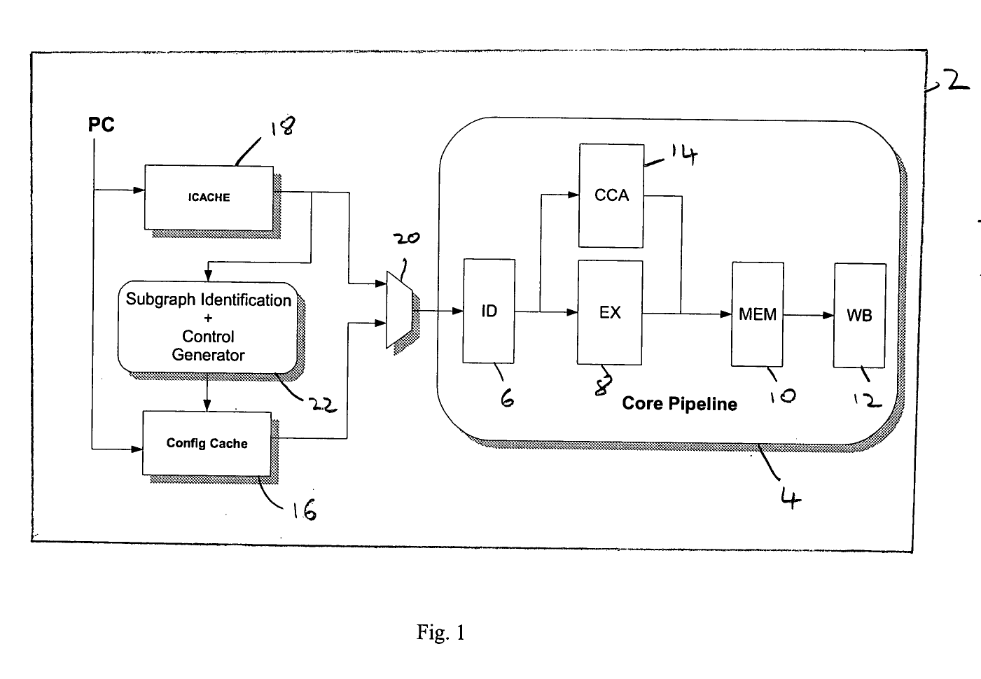

FIG. 1 illustrates an integrated circuit 2 including a general purpose processor pipeline 4 for executing program instructions. This processor pipeline 4 includes an instruction decode stage 6, an instruction execute stage 8, a memory stage 10 and a write back stage 12. Such processor pipelines will be familiar to those in this technical field and will not be described further herein. It will be appreciated that the processor pipeline 6, 8, 10, 12 provides a standard mechanism for executing individual program instructions which are not accelerated. It will also be appreciated that the integrated circuit 2 will contain many further circuit elements which are not illustrated herein for the sake of clarity.

A configurable accelerator 14 is provided in parallel with the execute stage 8 and can be configured with configuration data from a configuration cache 16 to execute subgraphs of program instructions as combined complex operations. For example, a sequence of add, subtract and logical combination instructions may be combined into a subgraph that can be executed as a combined complex operation by the configurable accelerator 14 with a single set of inputs and a single set of outputs.

Instructions are fetched from a program counter (PC) indicated memory location into an instruction cache 18. The instruction cache 18 can be considered to be part of an instruction fetching mechanism (although other elements will typically also be provided). The first time instructions are fetched they are passed via the multiplexer 20 into the processor pipeline 6, 8, 10, 12 as well as being passed to a subgraph identifier (and configuration generator) 22. The subgraph identifier 22 seeks to identify sequences of adjacent program instructions (which are either adjacent in the sequence of program instructions as fetched, or can be made adjacent by a permitted reordering) that can be subject to acceleration by the configurable accelerator 14 when they have been collapsed into a single instruction subgraph. The permitted reordering will be described in more detail later. When a subgraph has been identified which is within the capabilities of the configurable accelerator 14, then configuration data for configuring the configurable accelerator 14 to perform the necessary combined complex operation is stored into the configuration cache 16. When the program counter value for the start of that subgraph is encountered again indicating that the program instruction at the start of that subgraph is to be issued into the processor pipeline 6, 8, 10, 12, then this is recognized by a hit in the configuration cache 16 and the associated configuration data is instead issued to the configurable accelerator 14 so that it will execute the combined complex operation corresponding to the sequence of program instructions of the subgraph which are replaced by that combined complex operation. The combined complex operation is typically much quicker than separate execution of the individual program instructions within the subgraph and produces the same result. This improves processor performance.

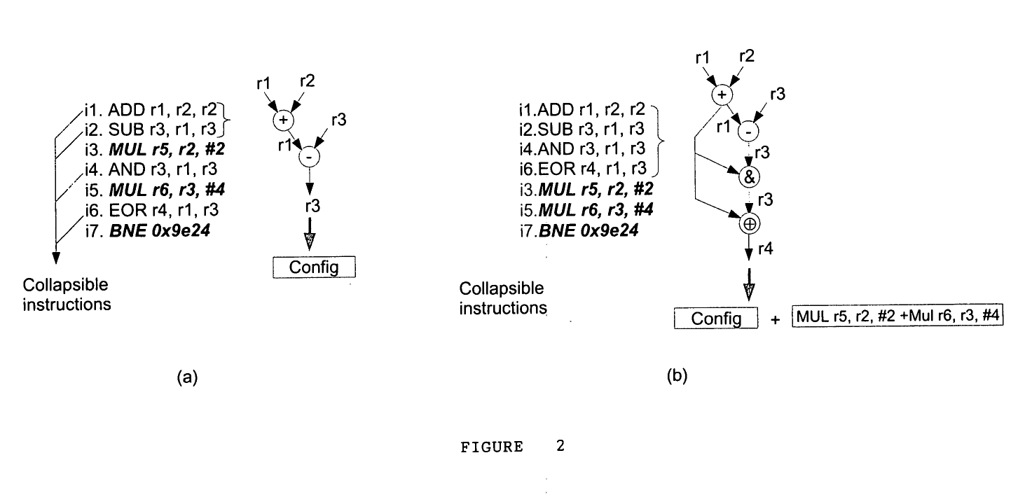

FIG. 2 illustrates on the left hand side a sequence of program instructions as fetched into the instruction cache 18. The instructions i1, i2, i4 and i6 form a subgraph capable of collapse into a combined complex operation and execution by the configurable accelerator 14. However, these instructions i1, i2, i4 and i6 are not adjacent to one another and accordingly a simple subgraph identifier only working with adjacent instructions would not identify this large four instruction subgraph as capable of acceleration. It will be noted that the instructions i3, i5 are multiply instructions and the configurable accelerator 14 in this example embodiment does not provide multiplication capabilities and accordingly these cannot be included within any subgraph to be accelerated. However, the inputs and outputs of these multiply instructions i3, i5 are not dependent upon any of the instructions i1, i2, i4, i6 and accordingly the multiply instructions i3, i5 can be reordered to follow the instructions i1, i2, i4, i6 without changing the overall result achieved. This is illustrated in the right hand portion of FIG. 2.

The subgraphs identified from combining nearly the first two instructions i1, i2 as would be achieved when limited to subgraphs of adjacent-as-fetched instructions and the subgraph which may be achieved through the use of appropriate reordering can be compared in FIG. 2 and it will be seen that the right hand subgraph is considerably longer and more worthwhile. The output of the subgraph identification and control generator 22 of FIG. 1 is configuration data for the configurable accelerator 14. In addition, the postponed multiple instructions i3, is are stored within a postpone buffer 24 and output together with the configuration data so as to be executed subsequent to the combined complex operation by the standard processor pipeline 6, 8, 10, 12 and this achieves the same final result as the originally fetched sequence of instructions. More specifically, the postponed instructions are “collected” in the postpone buffer 24 and then stored with the subgraph configuration in the configuration cache 16. The configuration along with the postponed instructions are then sent to the pipeline on a hit in the configuration cache 16.

Returning to FIG. 1, this can be seen to provide a general architecture that supports dynamic subgraph identification and extraction using the subgraph identifier and configuration generator 22 and the configurable accelerator 14. A configuration cache 16 is also provided to store the configuration data and the postponed instructions. The configuration cache 16 is indexed by the program counter (PC) value of the first instruction of each subgraph. At the fetch stage, assuming the configuration cache 16 is empty, the instructions are read from the instruction cache 18 and forwarded to the subgraph identification unit 22. Extracted subgraphs are stored within the configuration cache 16. At every instruction fetch, the instruction cache is checked to see if a previous subgraph was extracted starting from that program counter value. When a hit occurs, the configuration of the configurable accelerator 14 is sent to the pipeline and the program counter (PC) value adjusted accordingly to follow on from the identified subgraph.

Returning to FIG. 2, this shows seven instructions extracted from the dynamic instruction stream. The present technique seeks dynamically to extract subgraphs on reading instructions as they are decoded and to attempt to create as large as possible subgraphs by permitted reordering and operating within the capabilities of the configurable accelerator 14. A subgraph is sent for processing to extract an appropriate configuration for the configurable processor 14 when an instruction that cannot be mapped to the configurable accelerator 14 is encountered (non-collapsible instructions) or when the subgraph does not meet the configurable accelerator 14 constraints.

In the left hand portion of FIG. 2 the multiply instruction is not collapsible and accordingly if reordering was not used a subgraph consisting of only the first two instructions i1 and i2 would be identified. To address this problem, a postpone buffer 24 is introduced to store instructions that can be postponed and so enable larger subgraphs to be identified. The right hand portion of FIG. 2 shows the reordered sequence of program instructions in which the multiply instruction i3 is postponed since the subsequent instruction to be added to the subgraph does not read from its output (a read-after-write hazard) and does not write into registers read by the multiply instruction (a write-after-read hazard) or write into registers written to by the multiply instruction (a write-after-write hazard). The same is true of multiply instruction i5.

When a data dependency hazard, or an instruction that cannot be postponed (such as a branch) is encountered, the subgraph is sent for processing to generate the appropriate configuration data for the configurable processor 14. Furthermore, any postponed instructions within the postpone buffer 24 are appended to the configuration data so that they can be issued down the conventional processor pipeline 6, 8, 10, 12 following execution of the combined complex operation by the configurable accelerator 14.

The present technique also permits a scheme that speculatively predicts branch behavior when branches are encountered and extracts subgraphs spanning those branches (and accordingly spanning basic block boundaries). If the predicted branch behavior was not the actual outcome, then the pipeline and the result of the combined complex operation is flushed in the normal way which occurs on conventional branch misprediction. An output from the configurable accelerator 14 is provided that signals the condition upon which any conditional branch was controlled such that a check for the predicted behavior can be made and flushing triggered if necessary.

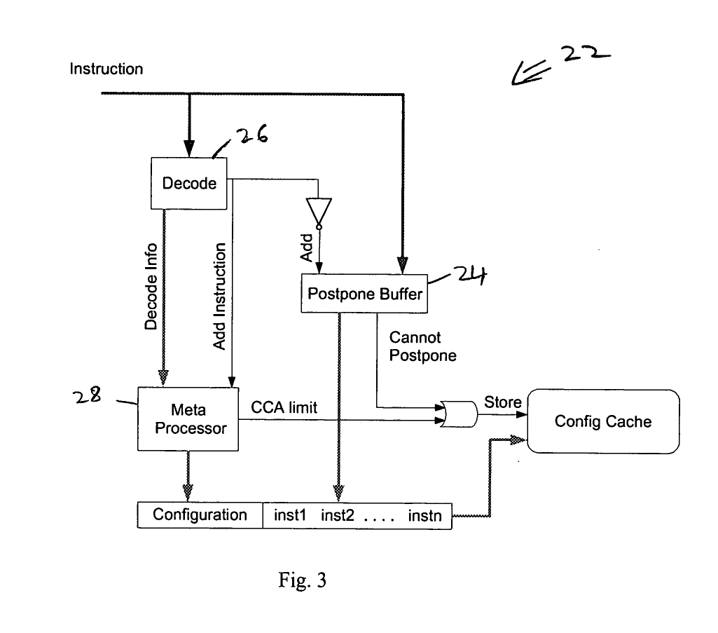

FIG. 3 shows in more detail a portion of the subgraph identifier and configuration generator 22. Instructions are first sent to a decoder 26 which determines if the instruction is collapsible (e.g. is of a type supported by the configurable accelerator 14). If the instruction is collapsible, it is sent to the metaprocessor 28 for processing to generate configurations for the configurable accelerator 14. The generation of configurations for such configurable accelerators is in itself known once the subgraphs have been identified and will not be described further herein.

If the instruction fetched is not collapsible, then it is sent to the postpone buffer 24. Every subsequent collapsible instruction is checked against source and destination operands in the postpone buffer to detect dependency hazards. Such dependency checking is a technique known in the context of multiple issue processors or out of order processors. In the present context, the hazard checking can be simplified since the complication of pipeline timing which may influence the dependencies and/or forwarding between pipelines and the like, need not be considered in this simplified lightweight hardware implementation.

If a subgraph is ended because the limitations of the configuration accelerator 14 are exceeded, or a violation in dependency in relation to instructions within the postpone buffer is noted, then the configuration and the postponed instructions are sent to the configuration cache 16.

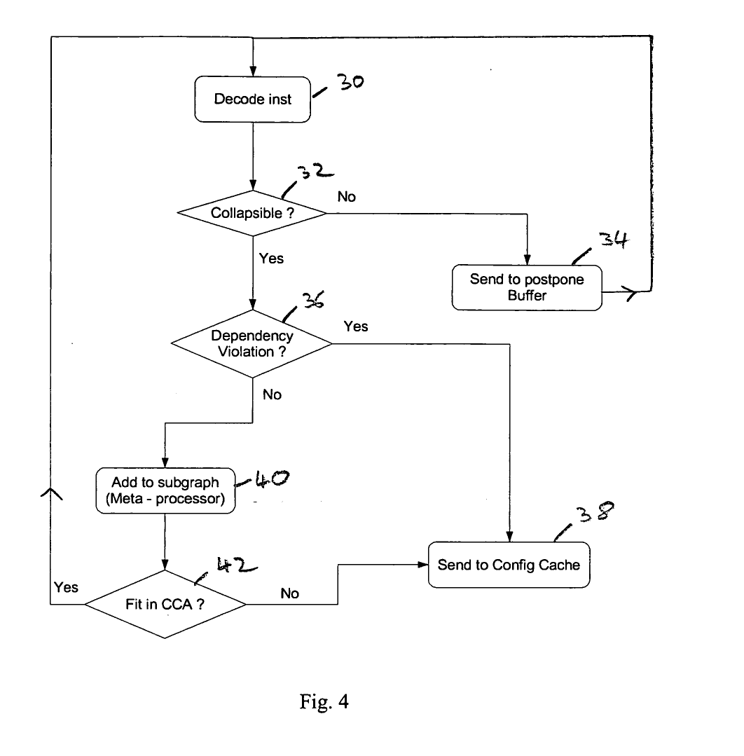

FIG. 4 schematically illustrates a flow diagram for the operation of the system of FIG. 3. At step 30 an instruction is decoded. Step 32 determines whether nor not that instruction is collapsible. If the instruction is not collapsible, then it is sent to the postpone buffer 24 at step 34 before processing is returned to step 30 for the next instruction. If the determination at step 32 was that the instruction is collapsible, then step 36 determines whether there is a dependency violation in relation to any of the instructions currently held within the postpone buffer 24. If there is such a dependency violation, then enlargement of the current subgraph is not taken further and the current configuration generated by the metaprocessor 28 is sent to the configuration cache 16 at step 38. If there is not a dependency violation at step 36, then step 40 seeks to add the collapsible and non-violating instruction to the subgraph and passes it to the metaprocessor 28. At step 42 the metaprocessor 28 determines whether or not the capabilities of the configurable accelerator 14 are exceeded by adding that further program instruction to the subgraph. If such capabilities are exceeded, then the preceded configuration for the subgraph without that added instruction is sent to the configuration cache at step 38, otherwise processing is returned to step 30 to see if a still further program instruction can be added to the subgraph.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

### REFERENCES

1. N. Clark, M. Kudlur, H. Park, S. Mahlke, K. Flautner, “Application-Specific Processing on a General-Purpose Core Via Transparent Instruction Set Customization,” International Symposium on Microarchitecture (Micro-37), 2004.
2. S. Yehia and O. Teman, “From sequences of Dependent Instructions to Functions: An approach for Improving Performance without ILP or Speculation,” 31^{st} International Symposium on Computer Architecture, 2004.
3. Sassone, P. G. and Wills, “Dynamic Strands: Collapsing Speculative Dependence Chains for Reducing Pipeline Communication,” In Proceedings of the 37^{th} Annual International Symposium on Microarchitecture (Portland, Oreg., Dec. 04-08, 2004).
4. Yehia, S., Clark, N, Mahlke, S., and Flautner, K 2005. Exploring the design space of LUT-based transparent accelerators. In Proceedings of the 2005 International Conference on Compilers, Architectures and Synthesis for Embedded Systems (San Francisco, Calif., USA, Sep. 24-27, 2005).
5. Bracy, A., Prahlad, P., and Roth, A. 2004. Dataflow Mini-Graphs: Amplifying Superscalar Capacity and Bandwidth. In Proceedings of the 37^{th} Annual International Symposium on Microarchitecture (Portland, Oreg., Dec. 4-8, 2004).

We claim:

1. An integrated circuit comprising:
an instruction fetching mechanism operable to fetch a sequence of program instructions for controlling data processing operations to be performed;
a configurable accelerator configurable to perform as a combined complex operation a plurality of data processing operations corresponding to execution of a plurality of adjacent of program instructions;
subgraph identifying hardware operable to identify within said sequence of program instructions a subgraph of adjacent program instructions corresponding to a plurality of data processing operations capable of being performed as a combined complex operation by said configurable accelerator; and
a configuration controller operable to configure said configurable accelerator to perform said combined complex operation in place of execution of said subgraph of program instructions; wherein
said subgraph identifying hardware is operable to reorder said sequence of program instructions as fetched by said instruction fetching mechanism to form a longer subgraph of adjacent program instructions capable of being performed as a combined complex operation by said configurable accelerator.

2. An integrated circuit as claimed in claim 1, comprising a postpone buffer operable to store program instructions fetched by said instruction fetching mechanism and not identified by said subgraph identifying hardware as part of a subgraph capable of being performed as a combined complex operation by said configurable accelerator.

3. An integrated circuit as claimed in claim 2, wherein a program instruction is stored within said postponed buffer by said subgraph identifying hardware if said program instruction corresponds to a data processing operation not supported by said configurable accelerator.

4. An integrated circuit as claimed in claim 1, comprising an instruction execution mechanism operable to execute program instructions and operable to perform at least some data processing operations not supported by said configurable accelerator.

5. An integrated circuit as claimed in claim 4, wherein program instructions not within a subgraph to be performed by said configurable accelerator are executed by said instruction execution mechanism.

6. An integrated circuit as claimed in claim 1, wherein a subject program instruction is reordered by said subgraph identifying hardware so as to fall within a sequence of adjacent program instructions for a subgraph being formed and ahead of one or more postponed program instructions not to be part of said subgraph if said subject program instruction does not have any input dependent upon any output of said one or more postponed program instructions.

7. An integrated circuit as claimed in claim 1, wherein a subject program instruction is reordered by said subgraph identifying hardware so as to fall within a sequence of adjacent program instructions for a subgraph being formed and ahead of one or more postponed program instructions not to be part of said subgraph if said one or more postponed program instructions do not have any input overwritten by said subject program instruction.

8. An integrated circuit as claimed in claim 1, wherein a subject program instruction is reordered by said subgraph identifying hardware so as to fall within a sequence of adjacent program instructions for a subgraph being formed and ahead of one or more postponed program instructions not to be part of said subgraph if said one or more postponed program instructions do not have any output which overwrites any output of the subject program instruction.

9. An integrated circuit as claimed in claim 1, wherein said subgraph identifying hardware ceases to enlarge a subgraph being formed when a next program instruction of a type specifying a processing operation supported by said configurable accelerator is encountered and adding said next program instruction to said subgraph would exceed one or more processing capabilities of said configurable accelerator.

10. An integrated circuit as claimed in claim 1, wherein said configurable accelerator, said subgraph identifying hardware and said configuration controller together provide dynamic identification and collapse of subgraphs of program instructions, whereby said identification and collapse is performed at runtime.

11. An integrated circuit as claimed in claim 1, wherein said configurable accelerator, said subgraph identifying hardware and said configuration controller together provide a transparent hardware-based instruction acceleration whereby said configurable accelerator, said subgraph identifying hardware and said configuration controller do not require any modification of said sequence of program instructions fetched by said instruction fetching mechanism compared with an integrated circuit not containing said configurable accelerator, said subgraph identifying hardware and said configuration controller.

12. A method of operating an integrated circuit comprising the steps of:
fetching a sequence of program instructions for controlling data processing operations to be performed;
identifying within said sequence of program instructions a subgraph of adjacent program instructions corresponding to a plurality of data processing operations capable of being performed as a combined complex operation by a configurable accelerator, said step of identifying including reordering said sequence of program instructions as fetched to form a longer subgraph of adjacent program instructions capable of being performed as a combined complex operation by said configurable accelerator;
configuring a configurable accelerator to perform said combined complex operation in place of execution of said subgraph of program instructions; and
performing as said combined complex operation said plurality of data processing operations corresponding to execution of a plurality of adjacent of program instructions.

13. A method as claimed in claim 12, wherein program instructions fetched by said instruction fetching mechanism and not identified by said subgraph identifying hardware as part of a subgraph capable of being performed as a combined complex operation by said configurable accelerator are stored in a postpone buffer.

14. A method as claimed in claim 13, wherein a program instruction is stored within said postponed buffer if said program instruction corresponds to a data processing operation not supported by said configurable accelerator.

15. A method as claimed in claim 12, wherein at least some data processing operations not supported by said configurable accelerator are executed by an instruction execution mechanism.

16. A method as claimed in claim 15, wherein program instructions not within a subgraph to be performed by said configurable accelerator are executed by said instruction execution mechanism.

17. A method as claimed in claim 12, wherein a subject program instruction is reordered so as to fall within a sequence of adjacent program instructions for a subgraph being formed and ahead of one or more postponed program instructions not to be part of said subgraph if said subject program instruction does not have any input dependent upon any output of said one or more postponed program instructions.

18. A method as claimed in claim 12, wherein a subject program instruction is reordered so as to fall within a sequence of adjacent program instructions for a subgraph being formed and ahead of one or more postponed program instructions not to be part of said subgraph if said one or more postponed program instructions do not have any input overwritten by said subject program instruction.

19. A method as claimed in claim 12, wherein a subject program instruction is reordered so as to fall within a sequence of adjacent program instructions for a subgraph being formed and ahead of one or more postponed program instructions not to be part of said subgraph if said one or more postponed program instructions do not have any output which overwrites any output of the subject program instruction.

20. A method as claimed in claim 12, wherein enlargement a subgraph being formed ceases when a next program instruction of a type specifying a processing operation supported by said configurable accelerator is encountered and adding said next program instruction to said subgraph would exceed one or more processing capabilities of said configurable accelerator.

21. A method as claimed in claim 12, wherein said method provides dynamic identification and collapse of subgraphs of program instructions, whereby said identification and collapse is performed at runtime.

22. A method as claimed in claim 12, wherein said method provides transparent hardware-based instruction acceleration whereby said sequence of program instructions fetched does not require any modification compared with a sequence of program instructions not using said method.

23. An integrated circuit comprising:
an instruction fetching means for fetching a sequence of program instructions for controlling data processing operations to be performed;
configurable accelerator means for performing as a combined complex operation a plurality of data processing operations corresponding to execution of a plurality of adjacent of program instructions;
subgraph identifying means for identifying within said sequence of program instructions a subgraph of adjacent program instructions corresponding to a plurality of data processing operations capable of being performed as a combined complex operation by said configurable accelerator means; and
configuration controller means for configuring said configurable accelerator to perform said combined complex operation in place of execution of said subgraph of program instructions; wherein
said subgraph identifying means reorders said sequence of program instructions as fetched by said instruction fetching means to form a longer subgraph of adjacent program instructions capable of being performed as a combined complex operation by said configurable accelerator means.
